(19) United States
(12) Patent Application Publication
(10) Pub. No.: US 2008/0002569 A1
(43) Pub. Date: Jan. 3, 2008

(54) Method and apparatus for identifying a fault in a communications link

(76) Inventors: Mark W. Cole, Santa Rosa, CA (US); Nurettin Bal, Petaluma, CA (US); Richard S. Lopez, San Anselmo, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/479,129

(22) Filed: Jun. 30, 2006

(51) Int. Cl. H04J 1/16

(52) U.S. Cl. 370/216

(57) ABSTRACT

In optical Ethernet networks, receiver side link loss is not known on a transmitter side network element, and a transmitter at a receiver side network element does not know of the receiver side link loss without special, very expensive, optical transmitters or a Gigabit Media Independent Interface (GMII). Example embodiments of the present invention can accomplish informing a network node on the transmit side of a network link by disabling communications from a network node on a receive side of the network link to the network node on the transmit side of the communications link. The network node on the transmit side of the communications link detects the receiver side loss through this indirect technique and works within existing protocols of network nodes. Example embodiments can work on all optical Ethernet interfaces regardless of speed and is less expensive than employing optical transmitters designed to detect receiver side link loss.

### BACKGROUND OF THE INVENTION

Receiver side link loss is not known on a transmitter side network element, and a transmitter at a receiver side network element does not know of the receiver side link loss without special, very expensive, optical transmitters or a Gigabit Media Independent Interface (GMII), referred to herein as a GMII interface.

A GMII interface can detect receiver side link loss and inform a transmitter in the receiver side network element of the link loss for notifying the transmitter side network element. Expensive optical transmitters may have diagnostic capabilities, but most use lower cost and more widely available commodity parts that do not have this capability.

### SUMMARY OF THE INVENTION

An embodiment of the present invention is a method and corresponding apparatus for identifying a fault in a communications link. A first network device on a receive side of a communications link disables transmit direction communications on the communications link when it detects a link fault in a receive direction on the communications link. This creates a link fault that is detected by a second network device on a transmit side of the communications link. The first network device waits to allow the second network device to detect the link fault and attempt to autonegotiate or otherwise establish a new connection with the first network device. The first network device thereafter enables the transmit direction communications and identifies the operational state of the communications link. If the first network device continues to detect a link fault, it may repeatedly enable and disable communications in the transmit direction on the communications link to the second network device and report the link status so that appropriate repairs may be made.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram illustrating a network in which example embodiments of the present invention may be employed;

FIG. 2 is a block diagram illustrating a system of two Ethernet switches and links between their respective Tx and Rx interfaces in which example embodiments of the present invention may be employed;

FIGS. 3 and 4 are flow diagrams illustrating a sequence of events in and state of data communications between two Ethernet nodes configured to identify a fault in a communications link;

FIGS. 5A-5C are block diagrams illustrating interconnectivity of a system of two Ethernet nodes and links between their respective Tx and Rx interfaces;

FIG. 6 is a block diagram illustrating components of a processor used in identifying a fault in a communications link; and

FIGS. 7-9 are flow diagrams illustrating example embodiments identifying a fault in a communications link.

### DETAILED DESCRIPTION OF THE INVENTION

A description of example embodiments of the invention follows.

In optical Ethernet networks, methods to detect receiver side link loss on a transmit side of the network are complicated and expensive. Example embodiments of the present invention can accomplish informing a network node on the transmit side of a network link by disabling communications from a network node on a receive side of the network link to the network node on the transmit side of the communications link. The network node on the transmit side of the communications link detects the receiver side loss through this indirect technique and works within existing protocols of network nodes. Example embodiments of the invention can work on all optical Ethernet interfaces regardless of speed and is less expensive than employing more expensive optical transmitters.

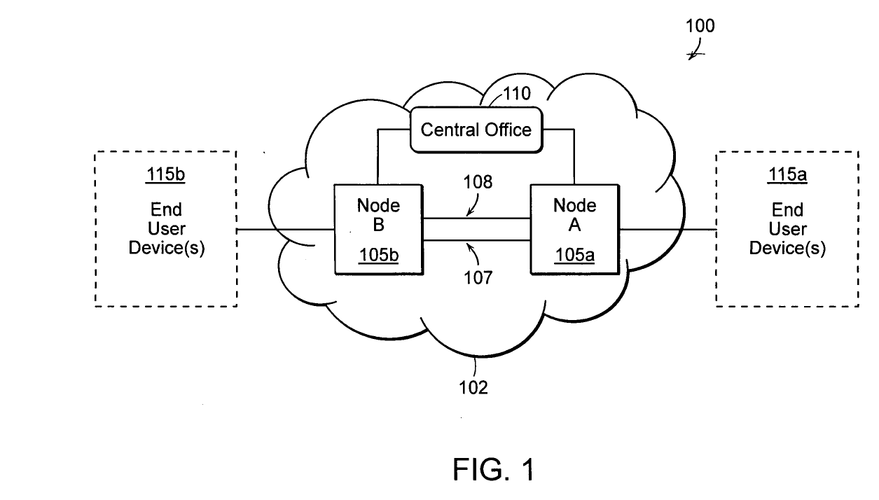

FIG. 1 is a network diagram 100 illustrating a network in which example embodiments of the present invention may be employed. A network cloud 102 contains two Ethernet nodes, node A 105a and node B 105b, which are interconnected by at least two communications links 107 and 108. A central office 110 is also part of the network cloud 102 and is in a monitoring role over the two nodes 105a, 105b. End user device(s) 115a, 115b are connected to node A 105a and node B 105b, respectively, and can represent terminals, Internet connections, Local Area Networks (LANs), or the like.

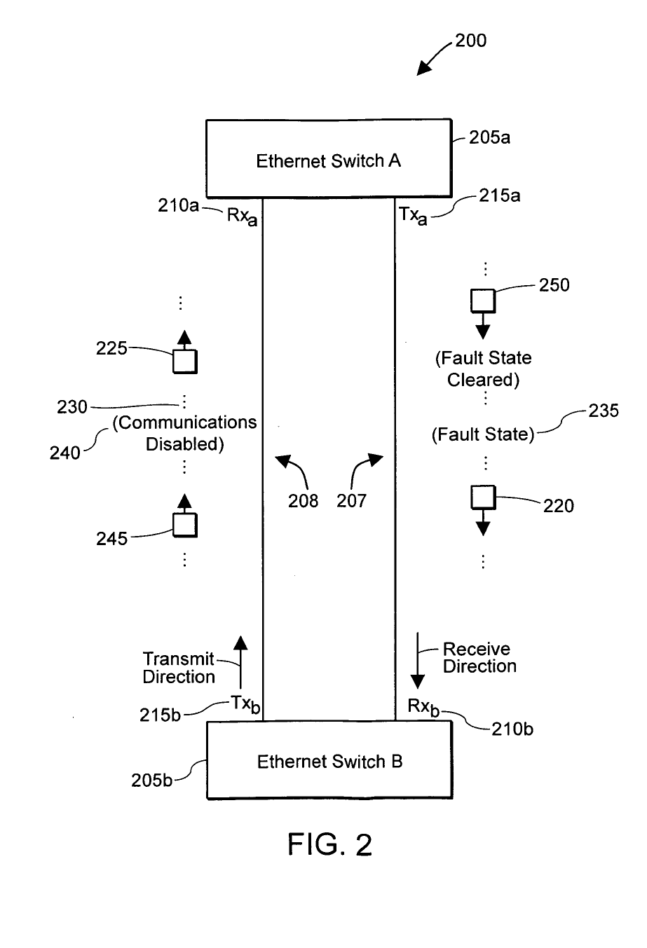

FIG. 2 is a block diagram 200 illustrating a system of two Ethernet switches, Ethernet switch A 205a and Ethernet switch B 205b, in which example embodiments of the present invention may be employed. The Ethernet switches have respective Tx and Rx interfaces 210a, 210b, 215a, 215b. Between the switches 205a, 205b are links 207, 208 that support Ethernet communications, such as optical Ethernet communications.

In operation of this example embodiment, Ethernet switch A 205a transmits communications 220 from its Tx interface 215a on a first communications link 207 to be received by Ethernet switch B's 205b Rx interface 210b. Responsive to or independent from the communications 220, Ethernet switch B 205b transmits communications 225 from its Tx interface 215b on a second communications link 208 to be received by Ethernet switch A's 205a Rx interface 210a. The communications 220, 225 may continue for an unspecified length of time.

The communications 220, 225 may include voice, data, speech, or other information. The communications links 207, 208 may be an optical communications link, wired communications link, or wireless communications link, such as a radio frequency or infrared communication link. Also, although illustrated as two communications link 207, 208, it should be understood that a single communications link may be employed (e.g., fiber optic), and the Rx/Tx interfaces 210a, 210b, 215a, 215b may be combined into respective transceivers with communications being carried on different frequencies in the different directions or isolated in some other manner known in the art.

Communications between Ethernet switch A 205a and Ethernet switch 205b are referenced herein from a point of view of one of the switches 205a, 205b on a case-by-case basis. For instance, from the point of view of switch B 205b, “receive direction” communications are the communications 220, 250 on the first communications link 207 and “transmit direction” communications are communications 225, 245 on the second communications link 208.

In an event Ethernet switch B 205b determines the communications link 207 enters a fault state 235 (e.g., a loss of signal occurs due to a link cut, Tx 215a failure, or other fault, such as a communication protocol error), in an example embodiment, Ethernet switch B 205b disables communications 225, 230 from itself to Ethernet switch A 205a to inform Ethernet switch A 205a indirectly that a fault on the first communication link 207 has been detected. Ethernet switch A 205a may then assist in attempting to correct the fault state of communications from Ethernet switch A 205a to Ethernet switch B 205b.

A “disabled” indicator 240 may be a length of time during which communications between Ethernet switch A 205a and Ethernet switch B 205b are discontinued or otherwise prevented from being received at Ethernet switch B 205b. It may also be a length of time in which “idle” messages or other representations of disabled communications are sent.

After waiting a given length of time according to the disabled indicator 240 to provide Ethernet switch A 205a an opportunity to restore the communications link, Ethernet switch B 205b may then resume sending communications 245 to Ethernet switch A 205a. The given length of time may be a predefined length of time, a length of time of at least ten seconds, or a length of time determined in a dynamic manner based on network conditions, such as loading or other factors.

Ethernet switch B 205b may then identify the status of the communications link. The status of the communications link may be identified by Ethernet switch B 205b by detecting communications 250 in the receive direction of the communications link 207. Ethernet switch B 205b may attempt to determine the status of the communications link 207 multiple times after re-enabling transmission of communications 245 to Ethernet switch A 205a in the transmit direction.

If the communications link is in a non-fault state, such that Ethernet switch B 205b is receiving communications 250 from Ethernet switch A 205a, the switches 205a, 205b resume normal operations. However, if the link 207 continues to remain in a fault state, Ethernet switch B 205b may report a link fault. Reporting the link fault may include sending a Loss of Signal alarm indicator to a central office (not shown). Alternatively, the disabling, enabling, identifying, and reporting may be repeated at least until the status of the communications link 207 is a non-fault state 250.

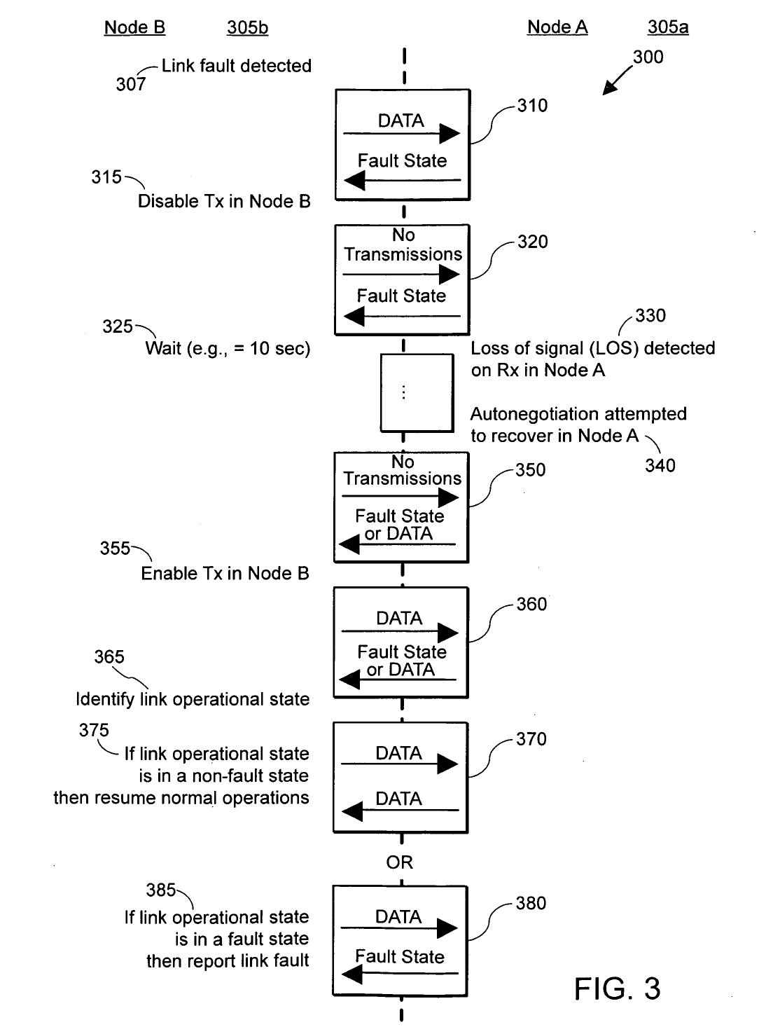

FIG. 3 is a block diagram 300 illustrating a sequence of events in and state of data communications between two Ethernet nodes, node A 305a and node B 305b, in identifying a fault in a communications link according to an example embodiment of the present invention. In this example embodiment, a link fault is detected 307 by node B 305b. The state 310 of data communications between node B 305b and node A 305a is such that node B 305b transmits data to node A 305a while the transmission of data from node A 305a to node B 305b is in a fault state.

In an event node B 305b detects a fault state, node B 305b disables 315 its transmissions to node A 305a. The resulting state 320 of data communications between node B 305b and node A 305a is such that node B 305b no longer transmits data to node A 305a while the transmission of data from node A 305a to node B 305b remains in a fault state. Data in this case means substantive data. Non-transmission of data or data representing an idle state or other non-substantive data may be communicated during the “no transmission” state in the transmit direction from node B 305b to node A 305a. Node B 305b then waits a length of time 325 so that node A 305a can detect 330 a loss of signal in its receiver and attempt to recover through autonegotiation 340 or other known recovery process. At this point, the state 350 of data communications between node B 305b and node A 305a remains such that node B 305b continues not to transmit data to node A 305a while the transmission of data from node A 305a to node B 305b remains in a fault state or data transmissions begin again.

After expiration of the amount of time to wait 325, node B 305b enables 355 its transmission to node A 305a. The state 360 of data communications between node B 305b and node A 305a becomes such that node B 305b transmits data to node A 305a while the transmission of data from node A 305a to node B 305b remains in a fault state or data from node A 305a to node B 305b is again active. Node B 305b may attempt to identify 365 the link operational state to determine the state of data communications from node A 305a to node B 305b. If the state 370 of data communications between node B 305b and node A 305a is such that the link is in a non-fault state (i.e., node B 305b transmits data to node A 305a and node A 305a once again transmits data to node B 305a successfully), the communications link can resume normal operations 375. However, if the state 380 of data communications between node B 305b and node A 305a is such that node B 305b transmits data to node A 305a but the transmission of data from node A 305a to node B 305b remains in a fault state, then node B 305b reports a link fault 385.

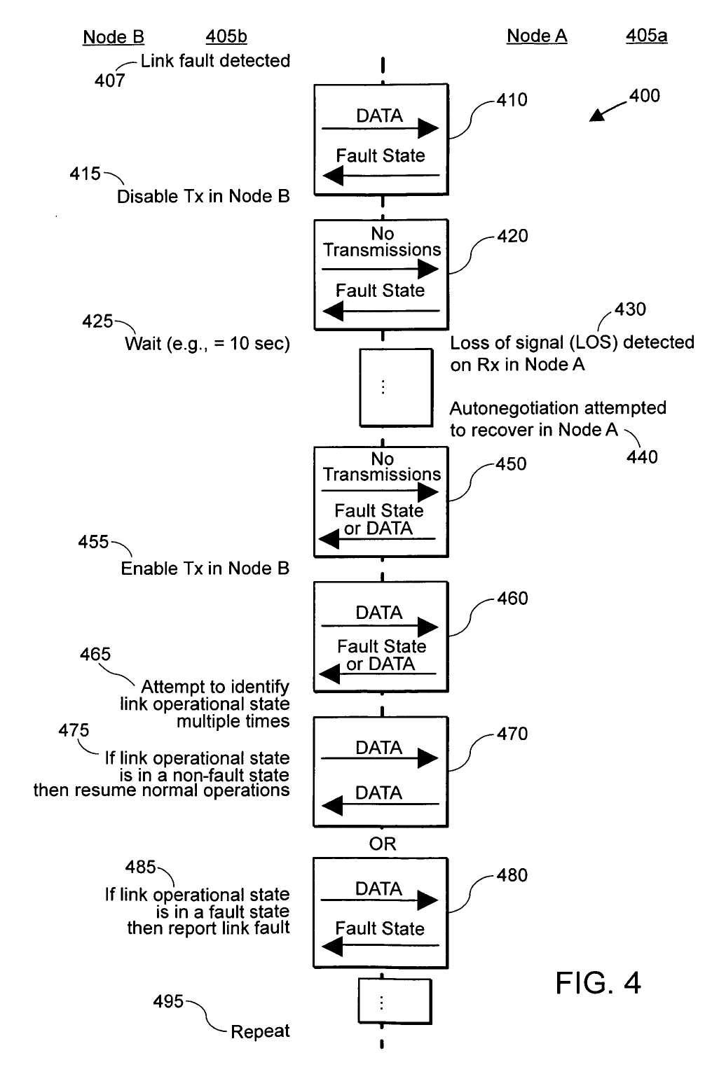

FIG. 4 is a block diagram 400 illustrating a sequence of events in and state of data communications between two Ethernet nodes, node A 405a and node B 405b, in identifying a fault in a communications link according to an example embodiment of the present invention. States and activities with similar reference numbers as in FIG. 3 (e.g., 300, 400; 307, 407; 310, 410; and so forth) are the same or similar to those presented above in reference to FIG. 3. The embodiment of FIG. 4 differs from the embodiment in FIG. 3 in that node B 405b may attempt multiple times to identify 465 the link operational state to determine the state of data communications from node A 405a to node B 405b. This means that node B 405b may make multiple attempts to detect data communications from node A 405a or, between states 460 and 480, node B 405b may disable, wait, and enable communications to node A 405a if communications from node A 405a are not detected. Alternatively, in this embodiment, node B 405b may repeat 495 the described flow diagram 400 having detected the link fault anew.

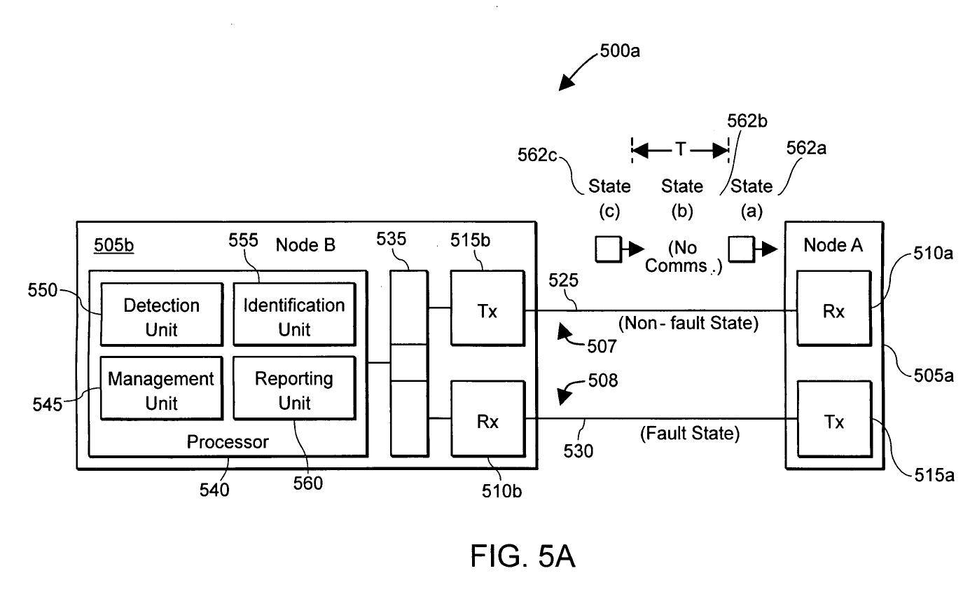

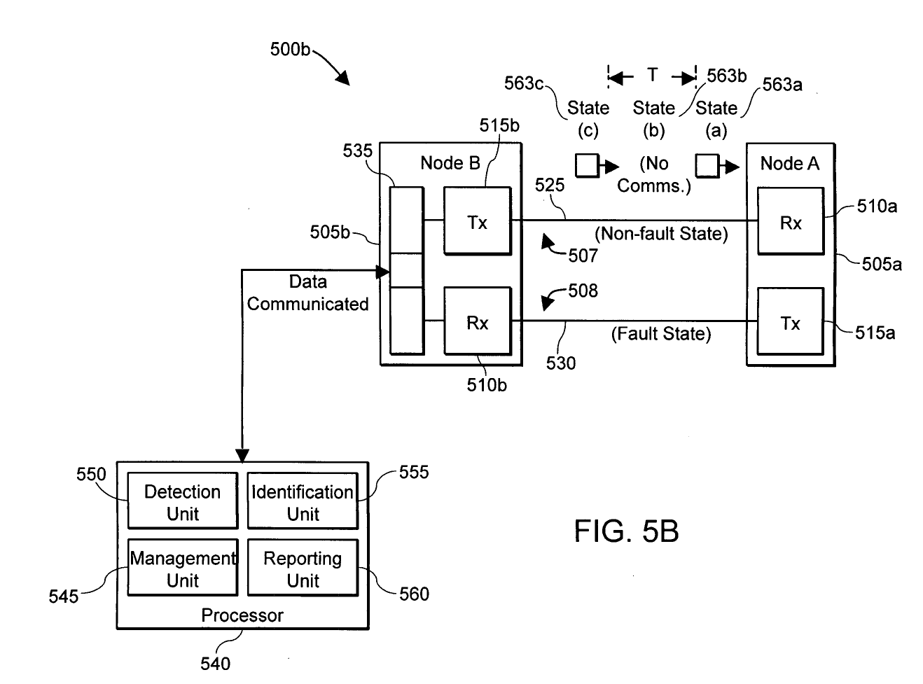

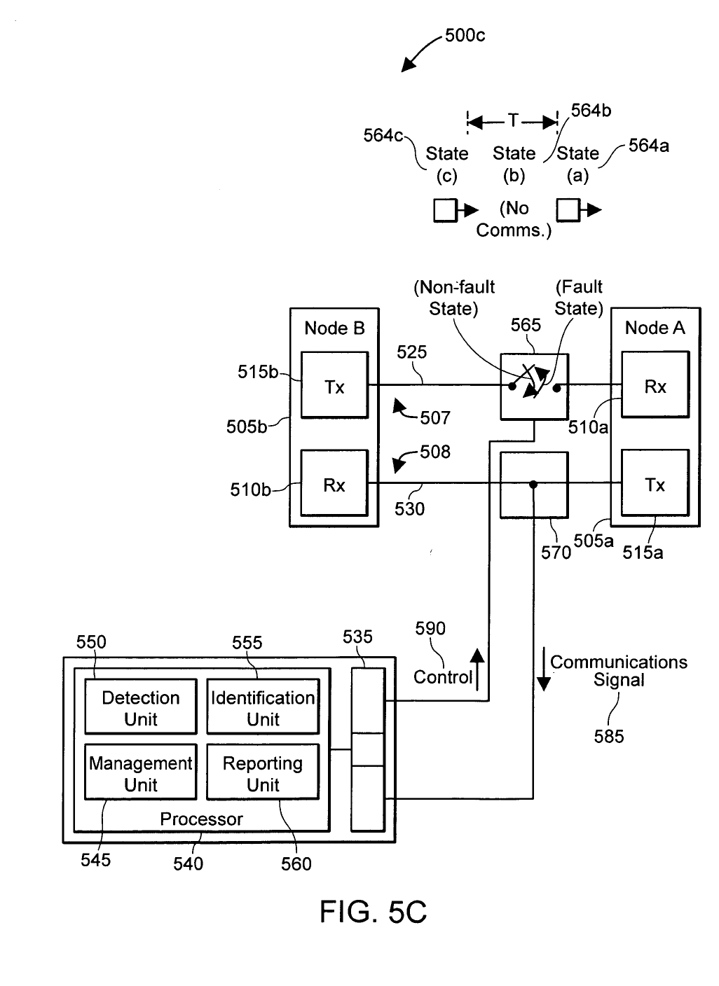

FIG. 5A is a block diagram illustrating interconnectivity 500a in a system of two Ethernet nodes and links between their respective Tx and Rx interfaces according to an example embodiment of the present invention. Node A 505a and node B 505b are connected by communications links 507, 508 through their respective Rx and Tx interfaces 510a, 510b, 515a, 515b. In this embodiment, a physical interface 535 connects the Rx interface 510b and Tx interface 515b of node B 505b to a processor 540 within node B 505b. A processor 540 contains a plurality of functional units, such as a management unit 545, detection unit 550, identification unit 555, and reporting unit 560.

In operation, the detection unit 550 may detect a link fault in a receive direction of a communications link 508. The management unit 545 responsively causes node B 505b to disable communications in a transmit direction of a communications link 507, represented as a transition from state (a) 562a to state (b) 562b. The management unit 545 causes node B 505b to enable communications in the transmit direction of the communications link 507 after a given length of time, represented as a transition from state (b) 562b to state (c) 562c. The identification unit 555 identifies an operational state of the communications link 508 after the given length of time, T. The reporting unit 560 reports a link fault in an event the operational state of the communications link 508 is in a fault state.

FIG. 5B is a block diagram illustrating interconnectivity 500b in a system of two Ethernet nodes and links between their respective Tx and Rx interfaces according to an example embodiment of the present invention. Node A 505a and node B 505b are connected by communications links 507, 508 through their respective Rx and Tx interfaces 510a, 510b, 515a, 515b. A physical interface 535 connects the Rx 510b and Tx 515b of node B 505b to a processor 540 outside node B 505b. The processor 540 contains a plurality of functional units, such as a management unit 545, detection unit 550, identification unit 555, and reporting unit 560.

In operation, the detection unit 550 may detect a link fault in a receive direction of a communications link 508. The management unit 545 responsively causes node B 505b to disable communications in a transmit direction of a communications link 507, represented as a transition from state (a) 563a to state (b) 563b. The management unit 545 causes node B 505b to enable communications in the transmit direction of the communications link 507 after a given length of time, represented as a transition from state (b) 563b to state (c) 563c. The identification unit 555 identifies an operational state of the communications link 508 after the given length of time, T. The reporting unit 560 reports a link fault in an event the operational state of the communications link 508 is in a fault state.

FIG. 5C is a block diagram illustrating interconnectivity 500c in a system of two Ethernet nodes and links between their respective Tx and Rx interfaces according to an example embodiment of the present invention. Node A 505a and node B 505b are connected by communications links 507, 508 through their respective Rx and Tx interfaces 510a, 510b, 515a, 515b. A physical interface 535 connects the communications taps 565, 570 to a processor 540. The processor 540 contains a plurality of functional units, such as a management unit 545, detection unit 550, identification unit 555, and reporting unit 560. In other embodiments, the processor 540 may alternatively have access to communications received by node B 505b or node A 505a as illustrated in FIG. 5B.

In operation, the detection unit 550 may detect a link fault in a receive direction of a communications link 508 by detecting a loss of the communications signal 585 at a first communications tap 570 or a high bit error rate or other typical fault indication. The management unit 545 responsively causes node B 505b to disable communications in a transmit direction of the communications link 507 by “breaking” the communications link 507 at a second communications tap 565, represented as a transition from state (a) 564a to state (b) 564b. The management unit 545 causes node B 505b to enable communications in the transmit direction of the communications link 507 after a given length of time by restoring the communications link 507 at the second communications tap 565, represented as a transition from state (b) 564b to state (c) 564c. The identification unit 555 identifies an operational state of the communications link 508 after the given length of time, T. The reporting unit 560 reports a link fault in an event the operational state of the communications link 508 is in a fault state.

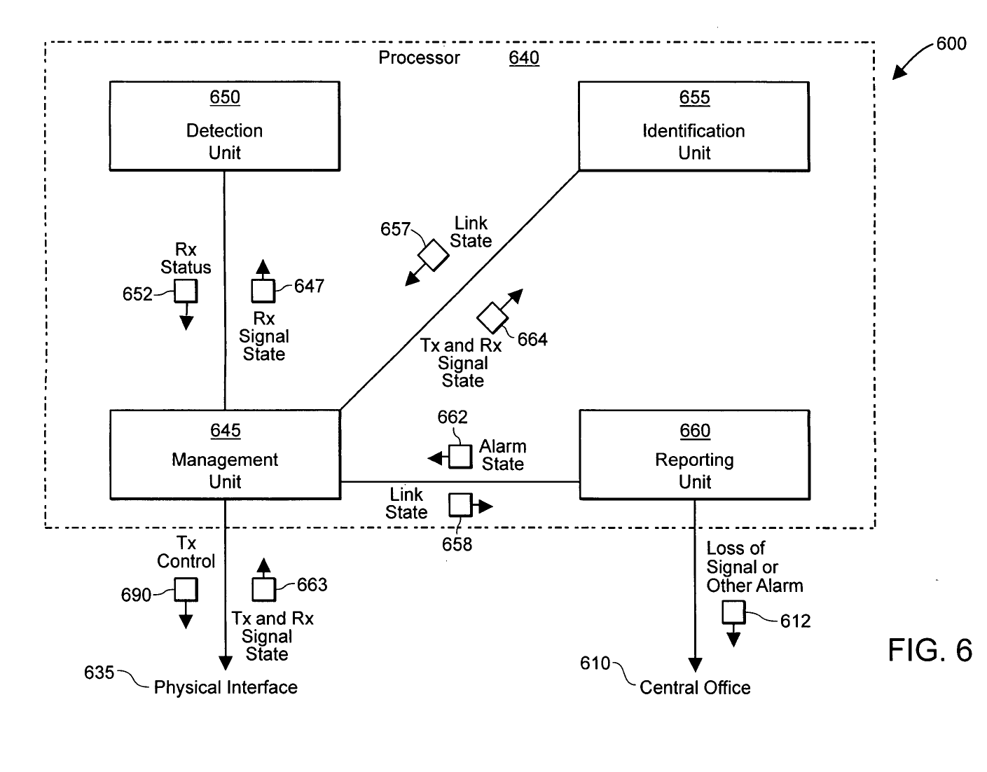

FIG. 6 is a block diagram 600 illustrating example components of a processor 640 used in identifying a fault in a communications link. The processor 640 may contain a plurality of functional units, such as a management unit 645, detection unit 650, identification unit 655, and reporting unit 660. The management unit 645 is connected to a physical interface 635 so it may monitor states 663 of Tx and Rx signals and issue a Tx control signal 690 that disables or indirectly disables Tx signals from a node that experiences receiver side link loss, as described in reference to FIGS. 5A-5C. The reporting unit 660 may communicate with a central office 610 to report a link fault in the form of an alarm or notification signal 612 in an event the operational state of the communications link is in a fault state.

The detection unit 650 communicates with the management unit 645. The management unit 645 sends a Rx signal state 647 to the detection unit 650 so that the detection unit 650 may detect a link fault in a receive direction of a communications link. Throughout its operation, the detection unit 650 sends a Rx status 652 that it has detected to the management unit 645.

If the detection unit 650 detects a link fault in a receive direction of the communications link and sends a Rx status 652 that it has detected to the management unit 645, the management unit 645, via the physical interface 635, responsively disables communications in a transmit direction of the communications link.

The identification unit 655 communicates with the management unit 645. The management unit 645 sends Tx and Rx signal states 664 to the identification unit 655 to identify an operational state of the communications link. The identification unit 655 sends the identified link state 657 to the management unit 645.

The reporting unit 660 communicates with the management unit 645. If a link state 657 identified by the identification unit 655 is in a fault state, the management unit 645 sends a link state 658 to the reporting unit 660. The reporting unit 660 sends a loss of signal or other alarm 612 to the central office 610. The reporting unit 660 then sends an alarm state 662 to the management unit 645. Alternatively, if the link state 657 identified by the identification unit 655 is in a non-fault state, the link fault has been eliminated and the communications link resumes its normal operations.

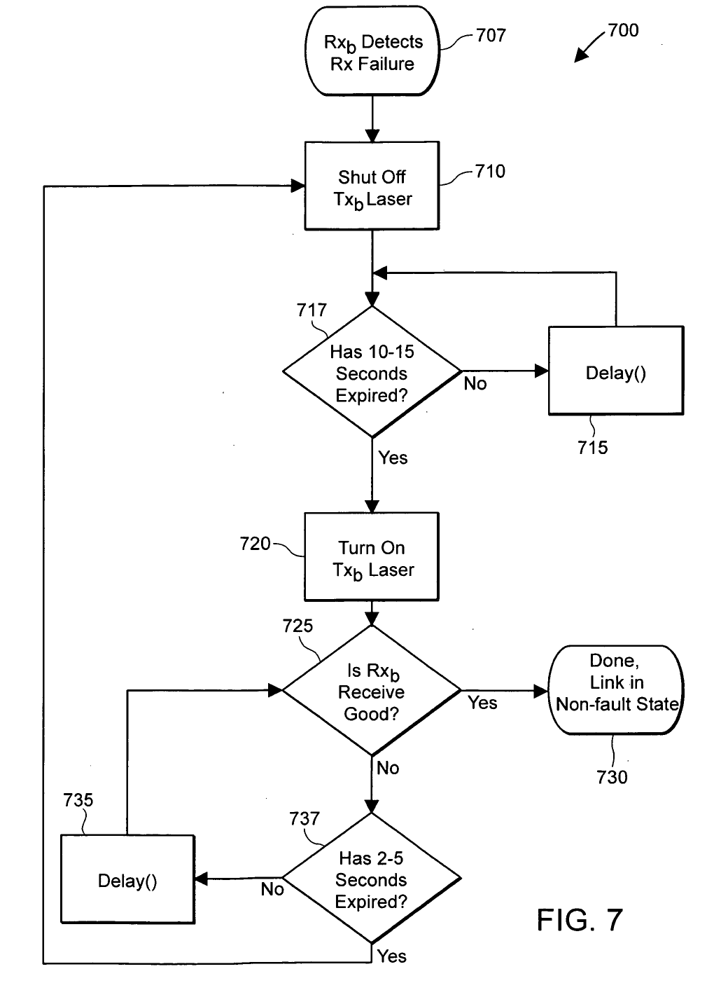

FIG. 7 is a flow diagram 700 illustrating a process performed in identifying a fault in a communications link in an example embodiment of the present invention. The flow diagram 700 starts by detecting a Rx failure 707 at a node, such as node B. Next, a transmission laser Tx_{b} 710 is shut off to induce a Rx failure at a second node, such as node A. The flow diagram 700 may enter a first delay loop 715 during which time node A detects a Rx failure and may attempt to autonegotiate a connection with node B.

In this example, the delay period of the first delay loop 715 is ten to fifteen seconds 717, but other lengths of time may be used, depending on various factors, such as network requirements or congestion. Once the delay period 717 of the first delay loop 715 has expired, the flow diagram 700 may turn the transmit laser on 720 in node B to resume data transmission on Tx_{b}. Next, the flow diagram 700 tests whether Rx_{b} is receiving data 725. If it is, the data link has been restored, and the link is known to be in a non-fault state 730. Otherwise, the flow diagram 700 enters a second delay loop 735, during which time there may be repeated checks to determine whether the data link has been restored. In this example, the delay period of the second delay loop 735 is two to five seconds 737, but other lengths of time may be used, again, depending on various factors. Once the delay period 737 of the second delay loop 735 has expired, the flow diagram 700 may repeat, starting by shutting off 710 the transmit laser.

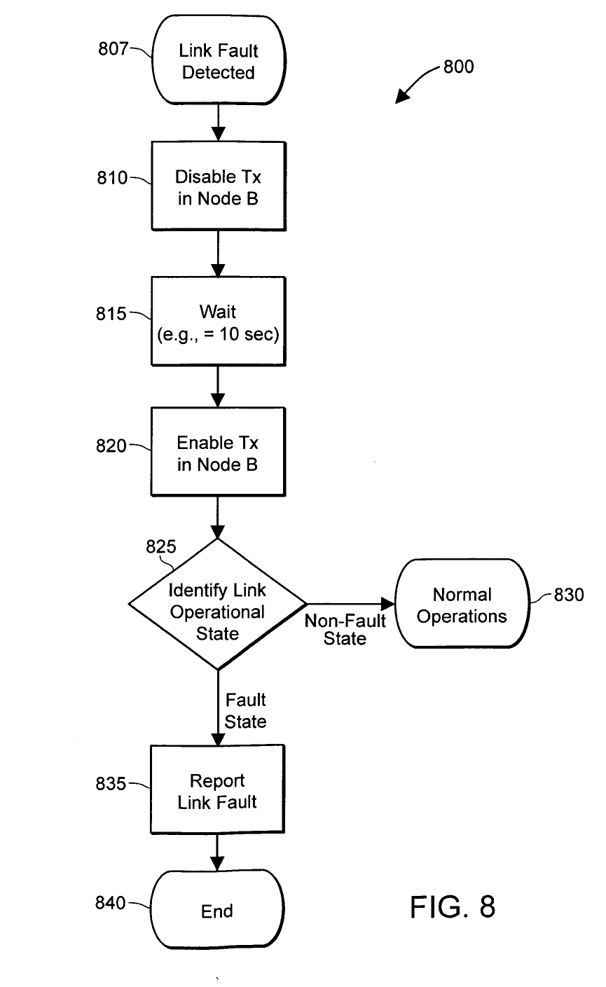

FIG. 8 is a flow diagram 800 illustrating a process performed in identifying a fault in a communications link in an example embodiment of the present invention. The flow diagram 800 starts by detecting a Rx failure 807 at a node, such as node B. Next, a transmission laser Tx_{b} 810 is shut off to induce a Rx failure at a second node, such as node A. The flow diagram 800 may wait a length of time 815 during which node A detects a Rx failure and may attempt to autonegotiate a connection with node B. In this example, the length of time 815 is ten seconds or more, but other lengths of time may also be used. Once the length of time 815 has expired, the flow diagram 800 may enable Tx (e.g., turn on the transmit laser 820) in node B to resume data transmission on Tx_{b}. Next, the flow diagram 800 identifies the link operational state 825. If the link is in a non-fault state, then the nodes using the link resume normal operations 830. Otherwise, if the link is in a fault state, the flow diagram may report the link fault 835 and end 840.

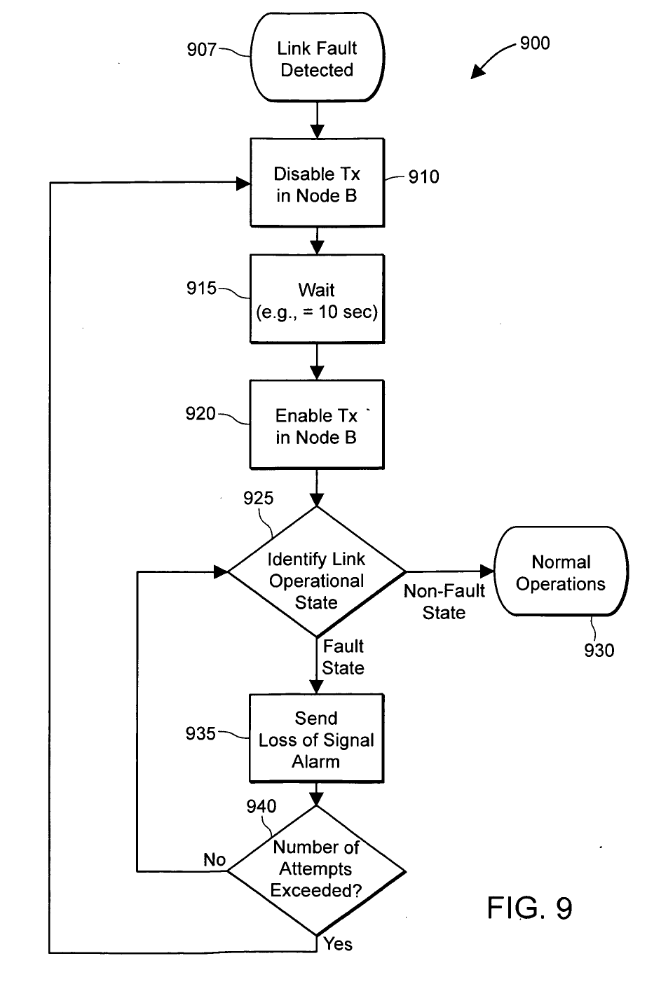

FIG. 9 is a flow diagram 900 illustrating a process performed in identifying a fault in a communications link in an example embodiment of the present invention. The flow diagram 900 starts by detecting a Rx failure 907 at a node, such as node B. Next, a transmission laser Tx_{b} 910 is shut off or transmissions from node B are otherwise disabled to induce a Rx failure at a second node, such as node A. The flow diagram 900 may wait a length of time 915 during which time node A detects a Rx failure and may attempt to autonegotiate a connection with node B. In this example, the length of time 915 is ten seconds or more. Once the length of time 915 has expired, the flow diagram 900 may turn on the transmit laser 920 in node B to resume data transmission on Tx_{b}. Next, the flow diagram may enter a loop 925 during which there may be repeated tests to identify the link operational state. If the link is in a non-fault state, the nodes using the communications link resume normal operations 930. Otherwise, if the link is in a fault state, the flow diagram may send a Loss of Signal or other alarm 935. If the number of attempts 940 in the flow diagram 900 to test whether the link is in a non-fault operational state has not been exceeded, the flow diagram may repeat, starting by identifying the link's operational state 925. Otherwise, if the number of attempts 940 has been exceeded, the flow diagram may repeat, starting by disabling Tx (e.g., shutting off 910 the transmit laser) by node B. The number of attempts 940 to repeat the processing may be configurable

While this invention has been particularly shown and described with references to example embodiments thereof, it will be understood by those skilled in the art that various changes in form and details may be made therein without departing from the scope of the invention encompassed by the appended claims.

For example., the processors of FIGS. 5A-5C and 6 may be a computer processor or multiple computer processors that execute software consistent with the corresponding embodiments presented above. In other embodiments, the processors are implemented in analog hardware, digital firmware, or combinations of hardware, firmware, or software.

It should be understood that the flow diagrams, such as FIGS. 3, 4, 7, 8, and 9 may be implemented in hardware, firmware, or software. If software, it may be stored on any form of computer readable media, such as RAM, ROM and so forth. The software may be any software language capable of supporting the embodiments disclosed herein. An application-specific or general processor may load, locally or remotely, and execute the software.

What is claimed is:

1. A method for identifying a fault in a communications link, the method comprising:
disabling communications in a transmit direction on a communications link responsive to detecting a link fault in a receive direction on the communications link;
enabling communications in the transmit direction on a communication link after a given length of time;
identifying an operational state of the communications link after the given length of time; and
reporting a link fault in an event the operational state of the communications link is in a fault state.

2. A method according to claim 1 further including repeating the disabling, enabling, identifying, and reporting at least until the operational state of the communications link is in a non-fault state.

3. A method according to claim 1 wherein identifying the operational state of the communications link includes detecting communications in the receive direction on the communications link.

4. A method according to claim 1 wherein identifying the operational state of the communications link includes checking the operational state of the communications link multiple times after enabling communications on the transmit direction on the communications link.

5. A method according to claim 1 wherein reporting a link fault in an event the operational state of the communications link is in a fault state includes sending a Loss of Signal (LOS) alarm to a central office.

6. A method according to claim 1 wherein the link fault is a failure or an error.

7. A method according to claim 1 wherein the communications link is an optical communications link.

8. A method according to claim 1 wherein the communications link is a wired communications link or a wireless communications link.

9. A method according to claim 1 wherein the given length of time is a predefined length of time.

10. A method according to claim 1 wherein the given length of time is at least ten seconds.

11. An apparatus for identifying a fault in a communications link, the apparatus comprising:
a detection unit to detect a link fault in a receive direction on a communications link;
a management unit to disable communications in a transmit direction on the communications link responsive to the detection unit's detecting the link fault and to enable communications in the transmit direction on the communications link after a given length of time;
an identification unit to identify an operational state of the communications link after the given length of time; and
a reporting unit to report a link fault in an event the operational state of the communications link is in a fault state.

12. An apparatus according to claim 11 wherein (i) the management unit is configured to repeat disabling and enabling communications in the transmit direction communications on the communications link; (ii) the identification unit is configured to identify the operational state of the communications link; and (iii) the reporting unit is configured to report the link fault at least until the operational state of the communications link is in a non-fault state.

13. An apparatus according to claim 11 wherein the identification unit is configured to identify the operational state of the communications link by the detection unit detecting data communications in the transmit direction on the communications link.

14. An apparatus according to claim 11 wherein the identification unit is configured to identify the operational state of the communications link by checking the operational state of the communications link multiple times after the management unit enables communications in the transmit direction on the communications link.

15. An apparatus according to claim 11 wherein the reporting unit is configured to send a Loss of Signal (LOS) alarm to a central office in an event the operational state of the communications link is in a link fault state.

16. An apparatus according to claim 11 wherein the link fault is a failure or an error.

17. An apparatus according to claim 11 wherein the communications link is an optical communications link.

18. An apparatus according to claim 11 wherein the communications link is a wired communications link or a wireless communications link.

19. An apparatus according to claim 11 wherein the given length of time is a predefined length of time.

20. An apparatus according to claim 11 wherein the given length of time is at least ten seconds.
